(19) United States
(12) Patent Application Publication
(10) Pub. No.: US 2013/0026196 A1
(43) Pub. Date: Jan. 31, 2013

(54) SELF CLOSING FLOW CONTROL DEVICE WITH ADJUSTABLE ACTUATOR ELEMENT FOR CONTAINER CLOSURES

(71) Applicants: Jan Essebaggers, Foster City, CA (US); Kateryna Davydova, Foster City, CA (US)

(72) Inventors: Jan Essebaggers, Foster City, CA (US); Kateryna Davydova, Foster City, CA (US)

(21) Appl. No.: 13/189,970

(22) Filed: Jul. 25, 2011

(51) Int. Cl. B67D 3/00

(52) U.S. Cl. 222/482

(57) ABSTRACT

The invention relates to a spill proof self-closing flow control device (SCFCD) with adjustable actuator element for flexible or rigid containers with fluids. The SCFCD comprises a spout, a flexible valve-retaining element and a container closure element. The valve-retaining element is a one-part component consisting of an actuator element, a cylindrical valve holder and a valve for alternately opening and closing the flow-through orifice. In the various embodiments two or three pressure chambers are formed with pressures P1, P2 and P3 controlling the flow control device, separated by the valve-retaining element. In a first, second and fourth embodiments the actuator element is configured to move in the downstream direction by an under pressure in the first chamber thereby bringing the valve in the open position, while in a third embodiment, the actuator element opens the valve in the upstream direction. Provisions are foreseen to increase the fluid outflow from container by externally adjusting the opening/closing force of the actuator element.

### CROSS-REFERENCE TO RELATED APPLICATIONS

“Not Applicable”

### STATEMENT REGARDING FEDERALLY SPONSORED RESEARCH OR DEVELOPMENT

“Not Applicable”

### REFERENCE TO SEQUENCE LISTING, A TABLE, OR A COMPUTER PROGRAM LISTING COMPACT DISC APPENDIX

“Not Applicable”

### BACKGROUND OF THE INVENTION

The invention relates to a container closure with a self-closing flow control device, axisymmetric in shape with an actuator element for rigid or semi rigid/flexible fluid containers which prevents spilling and leaking when the container is tipped over or overturned and easy to manufacture and use. The actuator element opening force is adjustable to increase a liquid outflow from the container for users with low suction capabilities such as toddlers, children, elderly people, etc. or for active users on-the go.

In U.S. Pat. No. 6,290,090 B1, self-closing flow control element is described, comprising a spout that is leak tight attached to a housing enclosure that holds a spring, a centrally perforated membrane, a hollow valve stem with flow through opening in the bottom and in the top, a valve stem guide and a valve, The hollow valve stem is attached to the perforated membrane on one side and to the valve on the other side. When suction is applied to the spout, the membrane moves the valve in the downstream direction, thereby allowing fluid to flow through an opening in the valve stem, the valve stem itself and the perforated membrane to the mouth. When the suction stops, a spring closes the valve against the pressure inside the container, The fluid opening to the valve extends through a flexible tube to the bottom of the container to allow emptying of the container completely. An air vent is provided within the valve stern guide, compensating for the reduction in pressure inside the container, when inside pressure drops below atmospheric pressure. The potential drawback of the above solution is in the arrangement of the valve stern guide, which protrudes into the container in such away that the container cannot be fully emptied unless an internal straw is used. in addition this solution requires a special configuration, which adds to the number of parts, thus affecting its reliability and increases the cost of manufacturing and assembly of the spout closure.

The present invention overcomes the above-mentioned drawbacks, by eliminating the valve stem guide in the container and placing the air inlet valve either within the one-way primary valve, or in the container closure element. The self-closing flow control device is thereby provided with an actuator element integrally connected via a valve holder to a primary valve, that opens a flow-through orifice in the downstream direction, while the exiting fluid volume in the container is replaced by air that flows back into the container through the secondary (air inlet) valve, as will become clear in the description of the first and second preferred embodiment below. The entire self-closing flow control device can be constructed from only three parts namely the spout, valve retaining element and the container closure element, thereby enhancing the reliability of the container closure means.

In WO 01/92133 A2, a flow control device is described in which the extruded portion of the membrane acts as a spout, and the valve opens in the upstream direction. The drawback of this solution is that the valve stem guide protrudes far into the container, thereby not allowing the container to be fully emptied and is not optimized in terms of parts used for its configuration, thus making the product more expensive to produce and also less reliable. The spout and the perforated membrane are combined into one-piece component of resilient material, making the mouthpiece of the spout very flimsy. A better conceptual solution has been described in the present patent application in a third preferred embodiment, thereby reducing the height of the valve holder and integrating the valve with the extruded portion of the perforated membrane and providing a plurality of valve stems, that at the same time adds strength and stability to the mouthpiece of the spout. In this embodiment the valve holder within the container has been eliminated thereby providing a flow-through orifice in the container closure element which is opened and closed by a valve connected to the centrally perforated membrane, with a mouthpiece and a valve holder integrally connected to the valve by valve sterns which at the same time reinforces the valve holder of the spout. These improvements become clear in the detail description of the third preferred embodiment below.

### BRIEF SUMMARY OF THE INVENTION

The object of the invention is to provide an optimized self-closing closure cap (adjustable or nonadjustable) for single serve liquid-holding bottles and containers that prevents the spilling of liquid when the bottle/container is accidentally tipped over or overturned, for drinking on the go and in awkward situation e.g. while driving in the car, when sporting, cycling, hiking etc. This objective is reached by providing the drinking means with a valve that automatically closes the bottle/container opening, when not being used and no suction is applied. There are three disclosed embodiments of the present invention making it applicable for different type of fluids (carbonated or still drinks), stored in containers of different shape and material, flexible or rigid.

The first embodiment of the present invention comprises a self-closing flow control device with a spout for drinking from a bottle or handheld container. The self-closing flow control device is activated by suction on the spout, whereby a centrally perforated membrane type element (further called “actuator element”) lifts a primary valve from a flow-through orifice, which closes the inside of the container from the outside. The inside of the container can be of a higher or equal gas pressure than the external atmospheric pressure. The self-closing flow control device comprises a spout with a mouthpiece, integrated or air tight connected to a housing or closing cylinder, which holds a pre-stressed actuator element, integrally connected to a central tube element, acting as a valve holder, that extends in the upstream direction. This valve holder is connected to a plurality of valve stems, (with a minimum of one), which are connected to the primary valve, in such away that when the actuator element moves up or down, the valve moves with it. The valve opens and closes a flow-through orifice in the center of a container neck closure element that at its periphery is leak tight connected to the rim of the container neck. The actuator element, valve holder and valve are integrated into one-piece component, which is made of a resilient material. By pre-stressing the actuator element during assembly of the self-closing flow control devise, the actuator element pulls the valve firmly onto its seat of the flow-through orifice. The lower side of the actuator element is held at atmospheric pressure due to one or more openings in the housing/closing cylinder of the flow control devise, while the upper side of the actuator element has a direct connection with the opening of the spout. By suction on the spout, a pressure difference is created over the actuator element, which opens the primary valve in the downstream direction of the fluid flow from the container, when the container is brought into drinking position. The valve closing area, respectively the orifice area is substantially smaller than the active surface area of the actuator element. A small pressure difference over the actuator element will thereby result in a relatively large force to open the valve against the resilient force that normally keeps the valve closed. The combination of the valve diameter, the resilient force and actuator diameter is thereby an essential part of the invention, enabling the self-closing flow control devise to work. When the pressure inside the container drops below atmospheric pressure, by the reduced fluid level, ambient air flows into the container through a secondary valve (air inlet valve), which is provided within the primary valve. This air inlet valve is one-way valve and opens only when the container pressure drops below the atmospheric pressure, thereby replacing the volume of the reduced fluid amount in the container. Thus described, the flow control devise securely closes off the inside of the handheld container against any spillage or when not in use. This embodiment is ideally suited for still and slightly carbonated beverages in a flexible container.

In a second embodiment of the invention, air inlet valves are placed in the container-neck closure element, allowing a continuous airflow into the container, when suction on the spout is applied, thus preventing deformation and distortion of the container shape and making it applicable to both; flexible and rigid containers. This solution is well suited for still and slightly carbonated beverages stored in rigid containers.

Unlike the self-closing flow control devise of the first and second embodiments, with the valve opening in the downstream direction, a third embodiment of this invention has a valve opening a flow-through orifice in the upstream direction. The valve is activated by a pressure difference over an actuator element, when suction is applied on the spout. The valve is thereby connected via a plurality of valve stems to a valve holder, which in turn is connected to the actuator element, having a protrusion in the downstream direction that acts at the same time as a spout. The valve stems are radially placed as protuberances on the inside of the valve holder, thereby improving the rigidness of this cylinder, while in addition a spout guide is provided, to improve the stability of the spout. This solution is well suited for carbonated beverages with an increased internal pressure, but requires a flexible container.

For a number of instances, it is desirable that the opening force of the actuator element is adjustable, for users with low suction capabilities, such as elderly, toddlers, hospital use etc., as well as active users looking for an increased outflow of fluid from the container. The opening force of the actuator element is externally adjusted either by rotation/twisting/pulling/pushing or snap-on means added to the self closing closure cap used for all types of containers flexible and rigid, metal or plastic. In addition, if used with the flexible container, the actuator element can be adjusted in such as way that by squeezing the bottle (in the two ‘first’ embodiments below), a continuous outflow of liquid can be obtained, which will automatically stop when the squeezing ceases.

### BRIEF DESCRIPTION OF SEVERAL VIEWS OF THE DRAWING

FIG. 1 is an axial cross-section of a first preferred embodiment and application of the present invention for a self-closing flow control device with actuator element opening a valve in the downstream direction.

FIG. 2 is a top view of FIG. 1 showing the spout, axisymmetric in shape, screwed onto a cylindrical container neck.

FIG. 3 is an enlargement view “S” of FIG. 1, showing details of the self-closing flow control device with the primary valve in the open position, and a secondary valve (air inlet slit valve) in the closed position.

FIG. 4 is an enlargement view “T” of FIG. 1, showing details of the self-closing flow control device with the primary valve in the closed position, and the slit valve in the open position, allowing air to flow into the container.

FIG. 5 is a detail cross-sectional top view A-A of FIG. 3 with the primary valve in the open and the slit valve in the closed position.

FIG. 6 is a detail cross-sectional top view B-B of FIG. 4 with the primary valve in the closed and the slit valve in the open position.

FIG. 7 is an enlarged cross-sec on “U” of FIG. 1, showing details of the self-closing flow control device with a skirt.

FIG. 8 is an enlarged cross-sectional view “V” of FIG. 1, showing details of the self-closing flow control device with a ridge in the actuator element adding flexibility to the actuator element, as needed.

FIG. 9 shows a second preferred embodiment of the self-closing flow control device wherein the slit valve in the primary valve is replaced by a self-closing, one-way air valve.

FIG. 9A shows an enlarged detail “W” of FIG. 9, with the primary and secondary valve in the closed position.

FIG. 9B shows a cross-sectional top view C-C of FIG. 9A.

FIG. 10 shows a second embodiment of the self-closing flow control device, in which one-way air valves are applied in the container closure element.

FIG. 10A shows an enlargement view “X” of FIG. 10, of a one-way air valve.

FIG. 11 is an axial cross-section of a second preferred embodiment and application of the present invention with air inlet openings in the peripheral area of the container neck closure element, closed off by a flexible washer, that also acts as a seal for the container neck.

FIG. 11A shows an enlarged view “Y” of FIG. 11.

FIG. 12 is an axial cross-section of a second preferred embodiment and application of the present invention with air inlet openings in the peripheral area of the container neck closure element, closed off by a flexible washer as part of the container neck closure element.

FIG. 12A shows an enlarged view “Z” of FIG. 12.

FIG. 13 is an axial cross-section of a third preferred embodiment and application of the present invention for a self-closing flow control device with actuator element opening a valve in the upstream flow direction, wherein the actuator element pulls the valve closed by a resilient force of the actuator element.

FIG. 13A is a partial cross-sectional top view D-D of FIG, 13 showing the spout axisymmetric in shape, screwed onto a container neck.

FIG. 14 shows a partial enlarged view “XX” of FIG. 13.

FIG. 15 is an axial cross-section of the third preferred embodiment and application of the present invention for a self-closing flow control device with actuator element wherein the valve is opened by a pressure difference (P1-P2)over the actuator element.

FIG. 16 shows a cylindrical extension within the actuator element, while the valve is in the closed position.

FIG. 17 is a partial top cross-sectional view E-E of FIG. 16.

FIG. 17A is an enlarged view of FIG. 17.

FIG. 18 shows a cylindrical extension within the actuator element, while the valve is in the open position.

FIG. 19 shows an enlarged view “YY” of FIG. 15 of the valve holder and a detail of the flexible valve, which is brought into position by one directional flexing structure of the valve through the orifice in the container closure element.

FIG. 20 shows a means to adjust the valve closure force by the actuator element for a valve that opens in the downstream direction.

FIG. 21 shows an enlarged detail “ZZ” of FIG. 20.

FIG. 22 shows a means to adjust the valve closure force by the actuator element for a valve that opens in the upstream direction.

FIG. 23 shows an enlarged detail “Z-Z” of FIG. 22.

### DETAILED DESCRIPTION OF THE INVENTION

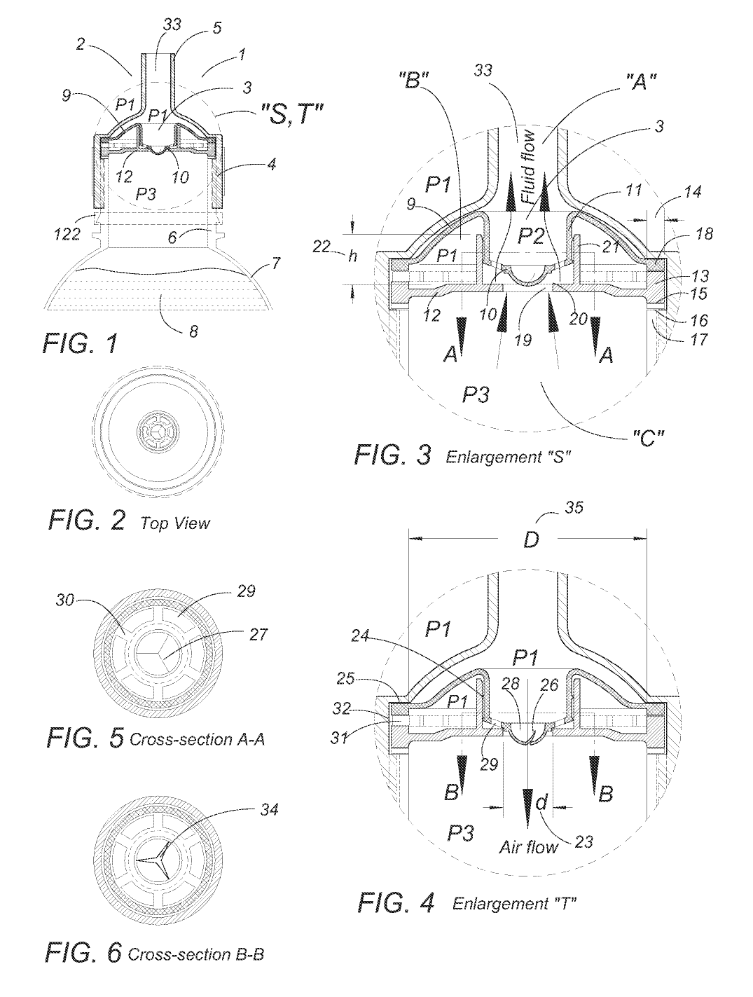

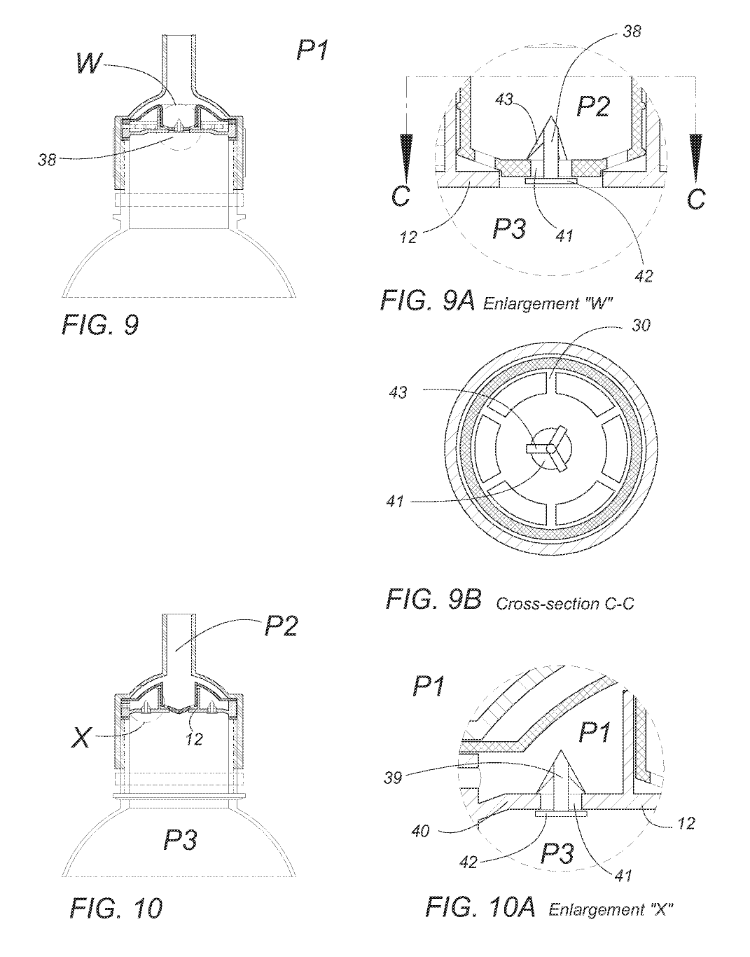

The present invention is now described in detail for the first preferred embodiment of the self-closing flow control device thereby referring to FIGS. 1-8, however, not limited thereto. The drawings of FIGS. 1-8 disclose one specific embodiment; axisymmetric in shape, while in FIGS. 9-12 a number of alternative solutions are shown as second embodiments of the invention. The self-closing flow control device has been described for a single serve bottle holding a drinking fluid. In this description the bottle is normally stored in the upright position and may be rigid or flexible depending on the opted embodiments. The bottle as such, however, is not part of this invention. The drawings as used to describe this invention refer to this upright position of the bottle, whereby the orientation of the self-closing flow control device is described in the same direction. Terms as upper/topside, bottom, horizontal etc. refer to this position of the bottle and closure cap. Although the invention has been described as being a closure cap for a single serve bottle, the invention is not restricted thereto and is applicable to all type of rigid or flexible containers of different designs holding a beverage or drinking fluid for consumption.

The first preferred embodiment of the invention is shown in FIG. 1, with a top view in FIG. 2 of which an enlargement “S” and “T” of FIG. 1 is shown in FIGS. 3 and 4. A self-closing flow control device assembly 1, comprising a spout 2 that is either detachable or integrally connected to a closing cylinder 4 having a inner screw thread, connecting to an outer screw thread of a bottleneck 6, which is part of a bottle 7, holding a drinking fluid 8. The self-closing flow control device assembly 1, comprises further a flexible actuator element 9, at its center integrally connected to a valve holder 11, with at its lower end a primary valve 10, that opens and closes a flow-through orifice 19. The bottleneck 6 is closed off with a disc type bottle closure element 12 having a cylindrical periphery 13, with a wall thickness 14 of which the lower side 15 is leak tight connected with a seal 16 to the rim 17 of bottleneck 6. The upper side of cylinder 13 is connected to the cylindrical rim 18 of the actuator element 9. The bottle closure element 12 has a central flow-through orifice 19, with at its periphery a valve seat 20. The upper side of the bottle closure element 12 is at its center integrally connected to a stationary cylinder element 21 with a height 22, large enough to allow the valve holder 11, which is integrally connected to primary valve 10 to move at least ¼ of the diameter 23 of orifice 19, in axial direction. The valve holder 11 as part of the actuator element 9 fits coaxial within the stationary cylinder element 21 with a leak and airtight axial sliding seals 24 between the valve holder 11 and the stationary cylinder element 21. The upper side of the cylindrical rim 18, as integral part of the actuator element 9, has an airtight seal 25 with the inner rim of spout 2. The one-way primary valve 10 holds at its center a secondary (one-way air inlet) valve 26. This air inlet valve 26 can he a slit valve having a plurality of slits 27 (with a minimum of one slit, while on the drawings 3 slits are depicted). These slits are normally closed and preferably shaped as part of a half globe 28, which is an integral part of the primary valve 10 in such a way that when pressure P3 inside the bottle is higher than or equal to the external atmospheric pressure P1, the slit valve is forced into the closed position. The circumference of primary valve 10 is integrally connected to the cylindrical valve holder 11 with spoke type elements 30 but at the same time has at its periphery a flow-through opening 29 allowing an open connection between the mouthpiece 5 with the inside of bottle 7, when the primary valve 10 is lifted from its seat 20. The actuator element 9, valve holder 11, primary valve 10 and secondary valve 26 configured preferably into one component of a resilient material, called a “valve retaining element” 3, while the remainder parts of the self-closing flow control device 1 are made of a harder less flexible plastic material. Thus described, a self-closing flow control device assembly 1 comprising three pressure chambers A, B and C, of which each chamber can have different pressures respectively P2, P1 and P3 in which P1 is the external atmospheric pressure. Chamber “A” is confined to the spout opening 33; inside of the spout 2; and upper side of the valve-retaining element 3. Chamber “B” is confined to the lower side of the actuator element 9, valve holder 11 and stationary cylinder 21 closed off by axial sliding seal 24, upper side of the bottle closure element 12 and its periphery cylinder 13. In cylinder 13 a plurality of openings 31 are provided, allowing ambient air to flow freely in and out through the threading of cylinder 4 and a circumferential air space 32 around cylinder 13, thereby keeping the pressure in chamber “B” at the atmospheric pressure P1. Chamber “C” is defined as the inside of bottle 7 at P3,

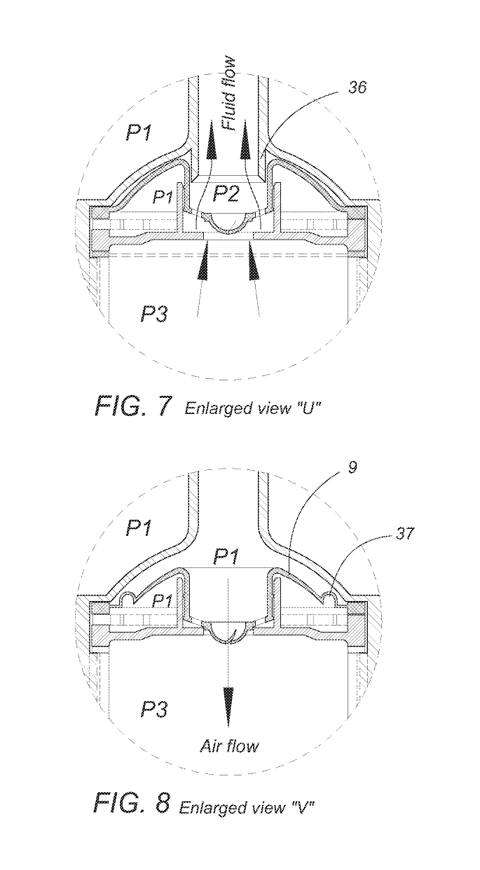

The working principle of the self-closing flow control device 1 is thus as follows: the bottle 7 with its contents 8 is normally stored in the upright position whereby the pressure in chamber “A” is equal to the pressure in chamber “B”, being P1. The primary valve 10 is positioned on its seat 20, closing off the inside of the bottle 7 from the outside. The pressure P3 in chamber “C” can be higher than P1 but not substantially lower. When drinking, the bottle 7 is held upside down in a drinking position and the pressure in the spout 2 is lowered to P2, causing a pressure difference P1-P2 over the actuator element 9. The actuator element 9 moves in the downstream direction, thereby lifting the primary valve 10 from its seat 20, resulting in a outflow of fluid 8 through orifice 19 and open flow area 29 to spout opening 33 and to the mouth. When drinking is stopped the pressure P2 within the spout opening 33 returns to the ambient pressure P1 and the primary valve 10 returns to its seat 20 by the resilient force of the valve retaining element 3 and the fluid outflow from the bottle is stopped. As fluid is withdrawn from the bottle, the pressure P3 in chamber “C” may drop below the ambient pressure P1. This pressure difference P3-P1 will than open the globular slit valve 26/28 causing an inward air flow through the open slit valve 34 (FIG. 6), bringing the inside pressure of the bottle to pressure Pl. This inflow of ambient air will persist as long as P3<P1, while no inflow of air will take place when P3>P1. The valve closing force caused by the resilience of the valve-retaining element 3 is one parameter in determining the maximum pressure P3 that can exist in the bottle 7. Another parameter in the proper functioning of the self-closing flow control device 1 is the active surface area of the actuator element 9 in relation to the flow-through area of the orifice 19. The maximum opening force “F” acting on the valve by suction on the spout is determined as F=π/4D²*(P1-P2)−π/4d²*(P3−P2), in which P3>P2 and P1>P2, and where π=3.14. This force F shall be larger than the resilient closing force of the valve-retaining element 3. Various provisions can be made to increase or decrease the resilient valve closing force of the valve-retaining element 3, e.g. by adding a ridge 37 to the actuator element 9 as shown in FIG. 8 and/or by changing the rigidness of the valve retaining element material and/or by adding additional closing means such as a spring (not shown) etc. Instead of a slit valve 26 of FIGS. 1-8, a one-way air inlet valve 38 of the type as shown in FIG. 9 and FIG. 10 respectively enlargements FIGS. 9A/B and 10A can be applied within the primary valve 10 of FIG. 3. In order to enhance the flow characteristics of the fluid, a skirt 36 can be added as shown in FIG. 7.

The above-described first preferred embodiment of the invention is applicable for flexible bottles that regain their shape when the air volume replaces the volumetric amount of fluid, withdrawn from the bottle.

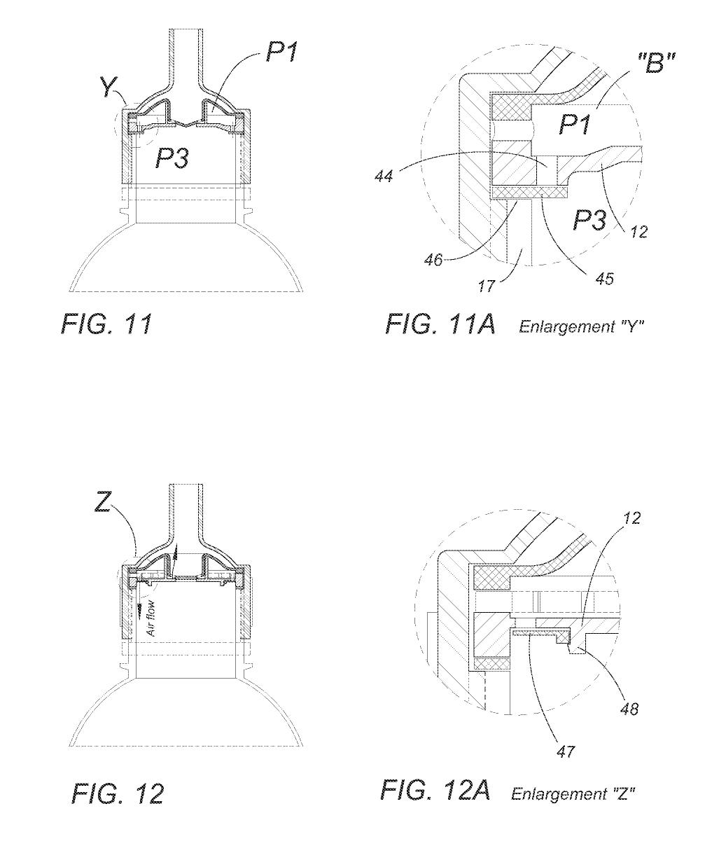

In a second embodiment one or more one-way air inlet valves 39 in the outer rim area 40 of the bottle closure element 12 of FIGS. 10 and 10A are provided. in this case ambient air in chamber “B” can freely flow into the bottle, when the pressure P3 becomes less than the ambient air pressure P1. The air valve assembly 39 is of a resilient material that closes off an opening 41 by an air inlet valve 42 in the bottle closure element 12. Valve 42 is drawn on its seat by a valve stem and three or more flexible protuberances 43 in star shape, thereby holding the air inlet valve 39 closed. Other provisions can be used to allow ambient air to flow into the bottle by openings 44 in the circumferential area of the bottle closure element 12, which are closed off by a flexible resilient closure ring 45 as shown in FIGS. 11 and 11A, which at the same time provides a seal 46 between the rim of the bottleneck 17 and the rim of the bottle closure element 12. In a similar way a flexible resilient closure ring 47 can be provided as shown in FIGS. 12 and 12A, which is held in place by a boss 48 of bottle closure element 12. The above solutions as depicted in FIGS. 9-12 and 9A, 9B, 10A, 11A, 12A are applicable to the second preferred embodiment of the self-closing flow control device 1, wherein a actuator element and valve are applied moving downstream, when suction is applied to the spout and fluid is withdrawn from a bottle. This embodiment is well suited for rigid containers.

A third embodiment is of a type whereby the valve moves upstream, when suction is applied to the spout, which is substantially different from the first and second embodiments of this invention and further in detail described hereinafter.

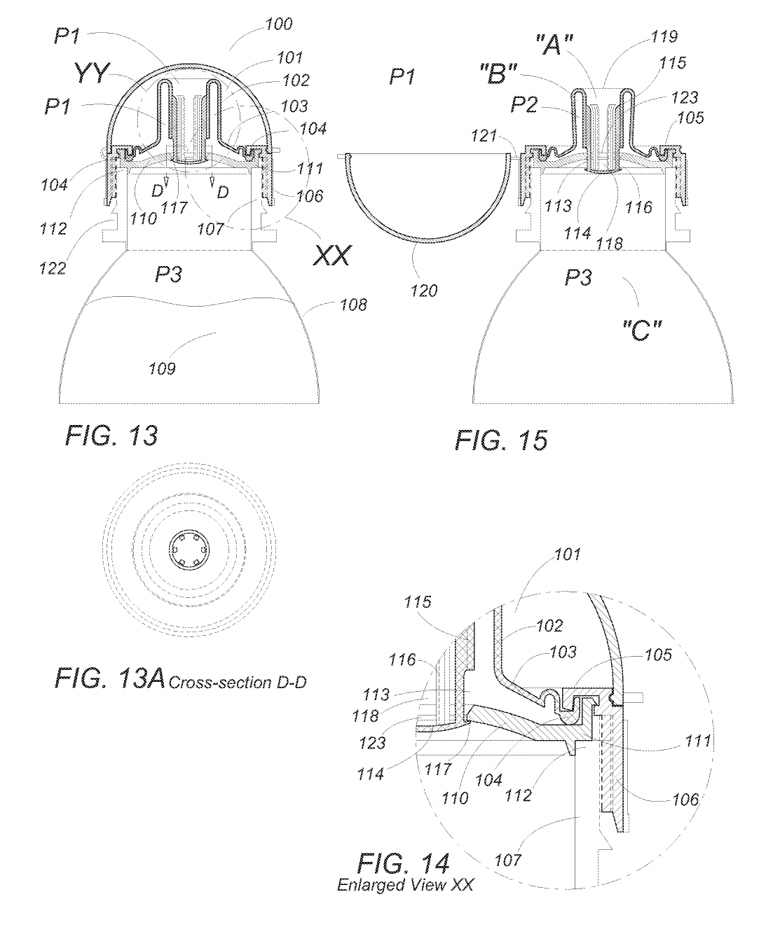

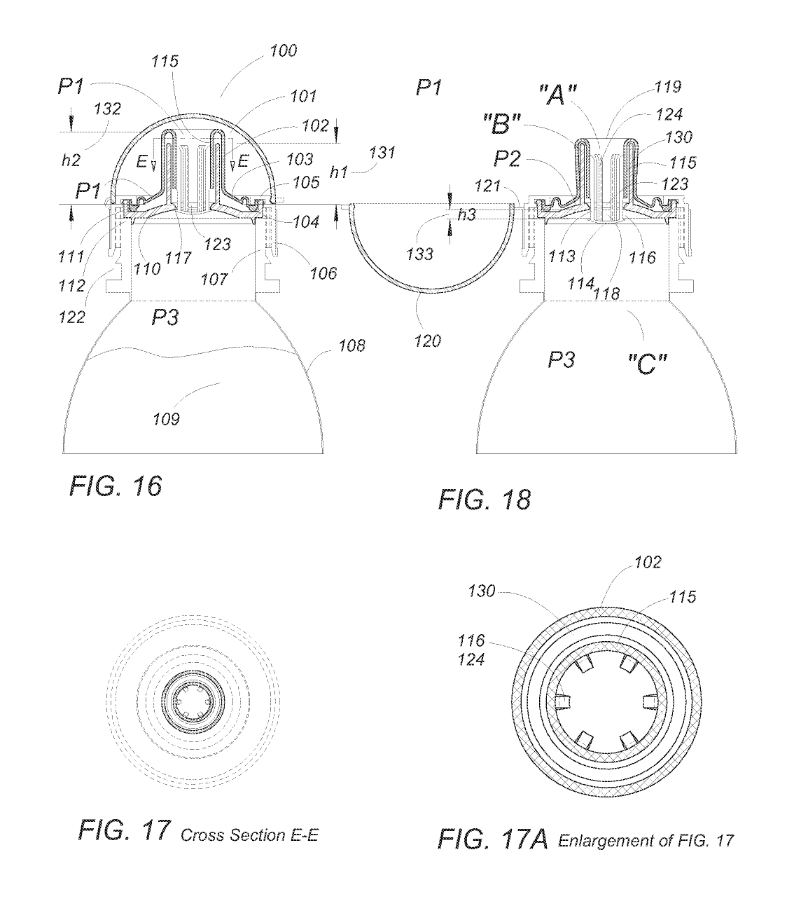

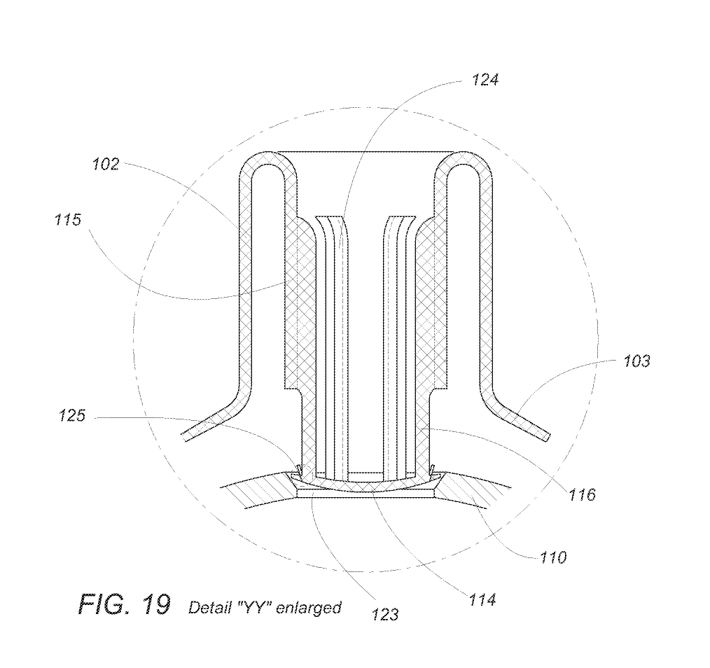

The description of this third preferred embodiment relates to a self-closing flow control device 100, which is axisymmetric in shape and of which a longitudinal cross-section is shown in FIGS. 13 and 15 with a top view in FIG. 13A, while an enlarged detail view XX is shown in FIG. 14 and an enlarged detail view YY in FIG. 19. FIG. 13 represents the self-closing flow control device holding a valve that closes off the inside of the bottle from the outside in its rest position, while in FIG. 15 the valve is in the active open position. The self-closing flow control device 100, consisting of a flexible spout 101 with a mouthpiece 102, being an integral part of an actuator element 103 with its periphery 104 sealingly connected to the periphery 111 of a bottle closure element 110 by the top of a closure cylinder 105 extending downwards 106 over a bottleneck 107, having on its inside screw thread, that connects with a screw thread of a bottleneck 107, being part of a flexible bottle 108, holding a drinking fluid 109. The bottleneck 107 is closed off by a bottle closure 110, which at its periphery 111 is sealingly connected to the rim 112 of the bottleneck 107, while at the center a flow-through orifice 123 is provided, that is normally closed off by a valve 114. The flexible spout 101, having a cylindrical mouth piece 102, is on the top side integrally connected to a valve holder 115, while at the lower side this valve holder 115 is connected to valve 114 by a plurality of valve stems 116 (with a minimum of one), which valve closes off orifice 123 in bottle closure 110. The actuator element 103 is pre-stressed, in such away, that it pulls the valve close to its seat 117. The lower part of the valve holder 115 has a flow through path 118 between the valve stems 116 allowing fluid 109 to pass when the valve 114 is in the open position, as shown in FIG. 15. The configuration as shown in FIGS. 15 and 18 show three chambers A, B and C, in which 3 different pressures can prevail Chamber “A” is defined by the inside of the valve holder 115, with an open end 119 at the top and the valve 114 at the bottom, Chamber “B” is defined by the inside of mouthpiece 102 the outside of the valve holder 115, the lower side of the actuator element 103 and the upper side of the bottle closure element 110. Chamber “C” is the inside of bottle 108, closed off by bottle closure 110 and valve 114, when the system is not in use. Chamber “B” has at the lower site of the valve holder 115 an open connection with chamber “A”. In its rest/closed position, the pressure in chamber “A” is equal to pressure in chamber “B”, being the external atmospheric pressure P1, while in chamber “C” a different pressure P3 can exist, which pressure can be larger, lower or equal to the external atmospheric pressure P1. When sucking on the self-closing flow control device 100, the pressure in chamber “A” will reduce below atmospheric pressure P1 to P2 (P2<P1). This results in a pressure difference (P1-P2) over the actuator element 103 causing the actuator element to move downwards. As the valve 114 is indirectly connected to the actuator element 103 via the valve holder 115 and mouthpiece 102, the valve will be pushed open, thereby moving in the upstream direction. This pressure difference (P1-P2) causes the actuator element 103 to move against the resilient closing three of the pre-stressed actuator element and the inside pressure of the bottle P3. When the bottle is turned upside down in the drinking position, the fluid 109 can now freely flow downstream to the spout and to the mouth. When drinking stops, the pressure difference P1-P2 becomes zero and the valve 114 returns to its seat 117, by the resilient force of the pre-stressed actuator element 101 Thus described a self-closing flow control device 100, holding a valve that closes automatically when drinking is stopped. This embodiment can be provided with, a dust cap 120 for cleanliness of the spout, which can be attached through a hinge 121 to the closure cylinder 106 or can be snapped onto this cylinder. Both the dust cap and the self-closing spout can be further completed with a tamper evident band 122 between the self-closing spout and the bottle and at the interface of dust cap 120 with closure cylinder 106, both not shown on the drawings. As the spout 101 shall move only in axial direction, a spout guide 130 can be added, which is an integral part of the bottle closure 110 and extending thereof in the down flow direction between the valve holder 115 and the mouthpiece 102 of the spout 101 as shown in FIGS. 1648, but with a height h1 (131) less than (h2−h3) (132/133). The thickness of this spout guide 130 shall allow adequate clearance with mouthpiece 102 and valve holder 115, in order to allow free air passage to chamber “B”. The valve 114 is of a flexible resilient material and is larger in diameter than the orifice 123 and needs to be brought in place through this orifice 123. In order to accomplish this, the rim 125 of the valve 114 is made to bend inwards (FIG. 19), while passing through the orifice 123, after which it bends backwards in such a way that it will remain in place and closes off the orifice 123 effectively, even when the internal pressure of chamber “C” at P3 is substantially higher than the external atmospheric pressure P1.

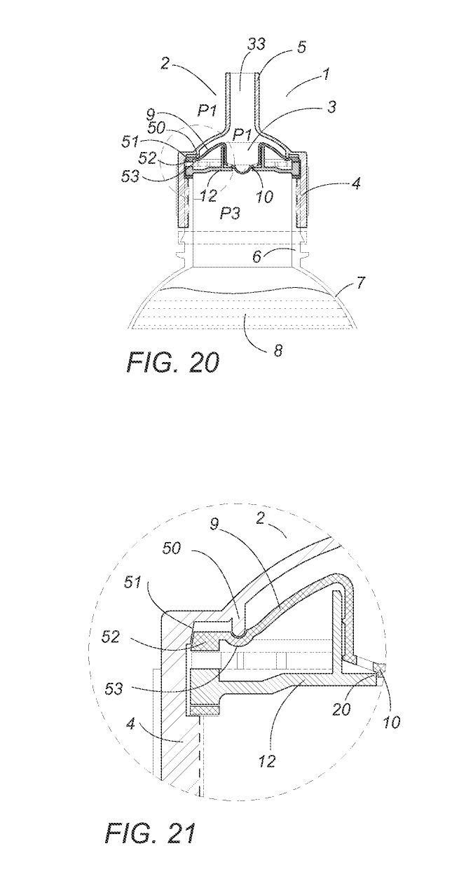

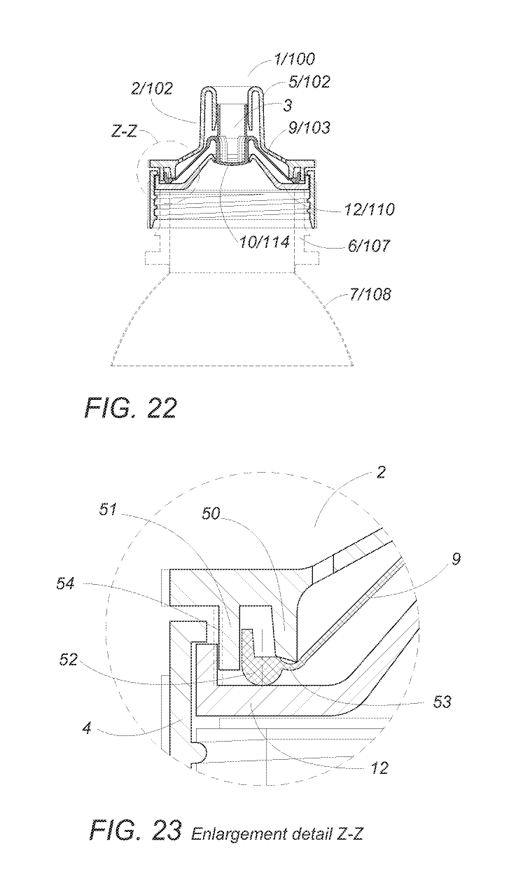

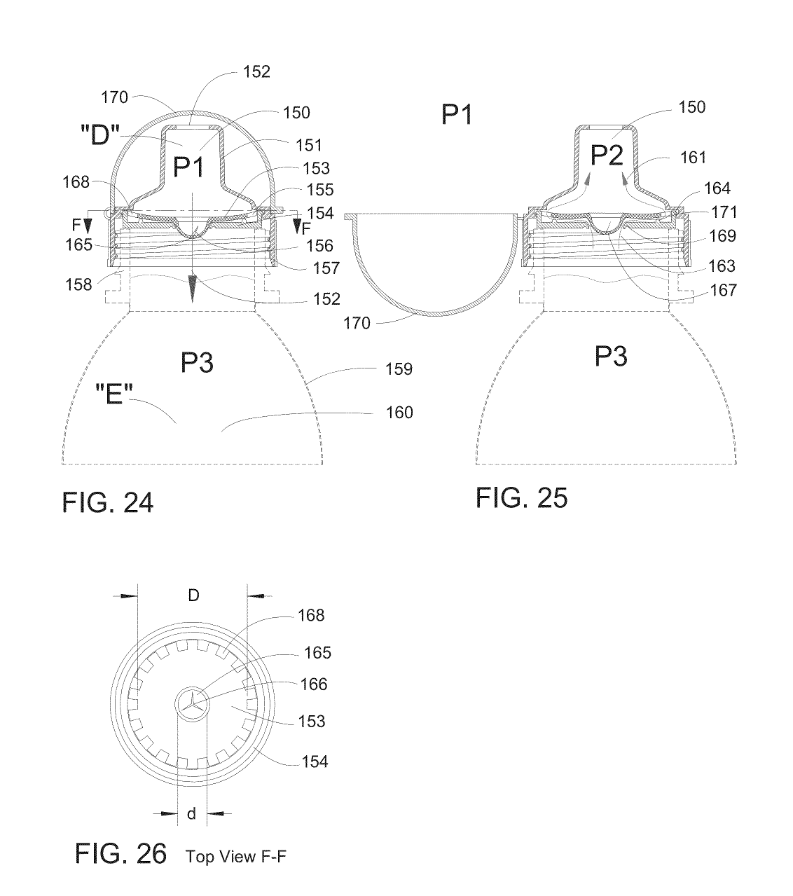

For the above-described embodiments the valve-retaining element can be made externally adjustable in such away that the valve is opened at different suction pressures P2. This is accomplished by a spout 2, having at the inside a cylindrical urging member 50, which is an integral part thereof, that will change the closing force of the valve retaining element 3 on the valve 10 by pushing the cylindrical urging member 50 into the actuator element 9 at some location close to the outer rim 52 of the actuator element as shown in FIG. 20, and of which an enlargement is shown in FIG. 21, thereby increasing the closing force on the valve 10 and visa versa. The spout 2 is thereby further screwed down onto the container neck 4, deforming the flexible actuator element at its periphery 52 and 53. This will result at the same time in a reduction of the active surface area of the actuator element, thereby increasing the suction pressure difference (P1−P2) to open the valve but at the same time allowing a higher internal pressure P3 in the container. A similar means is provided for a self-closing spout as shown in FIG. 22, with a detail view in FIG. 23, The spout 5/102 is thereby connected by a cylindrical element 51 being an integral part thereof, by a screw thread 54 to either the rim of the bottle closure element 12, or the bottle closure cylinder 4 (not shown). By screwing down the spout 5/102 onto the bottle closure cylinder 4, the urging member 50 increases/decreases the resilient opening/closing force on the valve 10/114.

1-19. (canceled)

20. A self-closing flow control device (SCFCD) for a bottle with a bottleneck, holding a drinking fluid, wherein said self-closing flow control device is detachably or permanently connected to said bottleneck, comprising a spout with a mouthpiece and a connecting threaded cylinder screwed onto said bottleneck thereby holding a flexible/resilient valve actuator element with an integrated primary valve and air inlet valve (secondary valve) that opens and closes a flow through orifice in a bottleneck closure element in the downstream flow direction, wherein said primary/secondary valve together with said bottleneck closure element forms a barrier for the fluid stored in the bottle and wherein said valve actuator element at its periphery is pushed down in such a way that the primary valve is pushed down onto its seat of the orifice of the bottleneck closure element, thereby forming two distinct pressure chambers “D” and “E” of which chamber “D” is formed between said spout, said valve actuator element and said primary/secondary valve, with pressure P1, while chamber “E” is basically the inside of said bottle at a pressure P3, in such away that P3<=>P1 and when suction is applied to the spout, the pressure in chamber “D” reduces to P2 with P2<P1, while P2 needs to become sufficiently low to overcome the resilient valve closing force of the actuator element thereby creating a pressure difference (P3−P2) over said primary valve, which shall be large enough allowing the primary valve to move in the downstream flow direction, thereby opening said flow-through orifice, after which chambers “D” and “E” will be in communication with each other and when the bottle is turned upside down in the drinking position, the fluid flows from the bottle (Chamber “E”) through the orifice, through a passage around the valve through the openings at the circumference of the actuator element into chamber “D” to the mouth, after which the valve will return to its seat by the resilient force of the pre-stressed valve actuator element, when no fluid is further required (P2−P1), however, when the pressure in the bottle P3 becomes less than the atmospheric pressure (P3<P1), the outside air will flow into the bottle (Chamber “E”) from chamber “D” through said air inlet valve (secondary valve), which is a part of the primary valve.

21. A self-closing flow control device of claim 20 in which the actuator element is pre-stressed in such away that the exerted force “F” keeps the valve closed, when the self-closing flow control device is not in use, while the circular cross-sectional area of the valve with diameter “d” is large enough to overcome the pre-stressed force “F.” and the primary valve opens when suction is applied on the spout and the pre-stressed force is smaller than the suction force on the valve [F<π/4*d²*(P3−P2)].

22. A self-closing flow control device of claim 21, wherein said—actuator element, is at its center integrally connected to said primary valve and said secondary air inlet valve (slit valve), configured into one-piece component made of a flexible material of which said actuator element is resiliently deformable, by virtue of its shape and material.

23. A self-closing flow control device of claim 21, wherein said primary valve allows a fluid to flow in one direction from the bottle, while a secondary air inlet valve allows air to flow in the opposite direction into the bottle, of which said air inlet valve can be incorporated into said primary valve in the main fluid stream, or outside this stream in said bottleneck closure element.

24. Said air inlet valve of claim 23 can be configured as a one-way slit valve, or one-way air valve(s) within the primary valve or opening and closing an air passage in the outer rim of the bottleneck closure element, which is (are) closed when the pressure within the bottle is higher than the ambient air pressure.

25. A self-closing flow control device of claim 20, wherein the opening-force of said actuator element is assisted by a small pressure difference Δp over the actuator element caused by the outward fluid flow on the lower side of the actuator element, by proper shaping the flow channel using a flow restriction on the periphery of said flow channel.

26. A self-closing flow control device of claim 20 applicable for single serve beverages, temporarily stored in rigid and/or semi rigid handheld containers or bottles.

27. A self-closing flow control device of claim 20 holding a flexible/resilient valve actuator element with an integrated primary valve that opens and closes a flow through orifice, whereby the valve clicks away from the valve seat, when suction is applied to the spout and clicks back onto its seat, when the suction stops and the SCFCD is not in use.

28. Said valve actuator element of claim 25, configured in such a way that the full pressure difference (P1−P2) acts on the total projected area of the valve actuator element, when suction is applied to the SCFCD.
